(19) United States
(12) Patent Application Publication
(10) Pub. No.: US 2025/0209881 A1
(43) Pub. Date: Jun. 26, 2025

(54) SYSTEM AND METHOD FOR DETECTING THE MAGNETIZATION OF A FLEXIBLE DOCUMENT

(71) Applicant: ARCA TECHNOLOGIES S.R.L., Bollengo (IT)

(72) Inventor: Massimo PAGANI, Bollengo (IT)

(73) Assignee: ARCA TECHNOLOGIES S.R.L., Bollengo (IT)

(21) Appl. No.: 18/986,547

(22) Filed: Dec. 18, 2024

(30) Foreign Application Priority Data
Dec. 21, 2023 (IT) 102023000027585

(51) Int. Cl. G07D 7/04; G01N 27/72

(52) U.S. Cl. CPC G07D 7/04; G01N 27/72; G07D 2207/00

(57) ABSTRACT

A system for detecting magnetization of a system includes: a conveyor to transport a flexible document along a path having initial and following sections; a first magnetization device to generate a magnetic field toward the initial section; a second magnetization device to generate a magnetic field toward the following section; a magnetization sensor to detect magnetization of flexible document's ferromagnetic elements, when the flexible document is at the following section; and output a corresponding magnetization signal, based on magnetization sensed; a control unit for synchronizing the flexible document's movement by sending control signals to the conveyor, the activation of the second magnetization device, the receipt of the magnetization signal outputted by the magnetization sensor and, based on the magnetization signal received, calculating the magnetization due to the hard ferromagnetic materials and magnetization due to soft ferromagnetic materials comprised in the flexible document's ferromagnetic element and outputting corresponding detection signals.

### BACKGROUND

The present invention relates to a system and a method for detecting the magnetization of flexible documents, such as banknotes and paper or polymer-based documents of various kinds.

In the following, flexible documents will mainly mean banknotes. However, it should be noted that the system and method according to the invention can be used to detect the magnetization of any other type of flexible document, including paper or polymer-based documents such as checks, certificates, licenses, coupons, vouchers, etc. provided that such documents include ferromagnetic elements, for example applied to or incorporated into such flexible documents, thereby remaining within the scope of protection of the present invention defined by the attached claims.

### STATE OF THE ART

Nowadays, many documents, especially banknotes, are equipped with ferromagnetic security elements of various types including, for example, metal threads or magnetic inks, which are used for their identification.

For this purpose, the banknotes are inserted into special detection systems, each equipped, among other things, with:
a magnetizing device, configured to magnetize the ferromagnetic elements of the banknote;
a magnetization sensor, configured for
   detecting the magnetization of such ferromagnetic elements thus magnetized, and
   outputting a corresponding magnetization signal;
a processing unit, configured to receive the magnetization signal as input, process it and output a corresponding detection signal, on the basis of which it is possible to determine, in a way known in the field, among other things, the denomination of the banknote and/or whether it is an authentic banknote or a counterfeit banknote.

The ferromagnetic elements of banknotes and, more generally, of the aforementioned flexible documents respond differently to the stresses of an external magnetic field applied thereto and can be classified into hard ferromagnetic elements or soft ferromagnetic elements, depending on the ferromagnetic material with which they are made.

In fact, hard ferromagnetic materials, of which for example the metal threads of banknotes are made, differ from soft ferromagnetic materials, of which for example some ferromagnetic inks are made, due to their hysteresis curve, presenting a residual magnetization (Br) which depends on the type of material and which in a hard ferromagnetic material still has a much greater value (even thousands of times greater) than the value of the residual magnetization of a soft ferromagnetic material. Furthermore, soft ferromagnetic materials have a much narrower hysteresis curve than that of hard ferromagnetic materials and, once magnetized, they lose their magnetization much more rapidly than the latter, in a natural way (i.e., without the application of any external demagnetizing magnetic field). The aforementioned traditional banknote magnetization detection systems are typically configured to detect the magnetization of the banknotes' ferromagnetic elements, which are made of hard ferromagnetic materials. These systems, despite being widely used, do not allow to appreciate minimal differences in magnetization, which are due to ferromagnetic elements of the banknotes that are made with soft ferromagnetic materials and this limits the reliability in the identification of the banknotes themselves. Not only that, traditional detection systems do not allow the position of the ferromagnetic security elements, which could vary, for example, between banknotes of different denominations and between authentic and fake banknotes, to be precisely located on the banknote. Not to mention the fact that manufacturers of counterfeit banknotes nowadays use materials for ferromagnetic security elements that are in-between hard ferromagnetic materials and soft ferromagnetic materials.

The need is therefore felt to improve the state of the art in the field of magnetization detection of a flexible document in general, and of a banknote in particular, and therefore the main object of the present invention is to allow in a simple, reliable and effective way detection of the magnetization of a flexible document, regardless of the nature of the ferromagnetic material included in one or more of its ferromagnetic safety elements, being it hard or soft ferromagnetic material.

Yet another object of the present invention is to recognize and distinguish, in a flexible document, the contributions to magnetization deriving from hard ferromagnetic materials and soft ferromagnetic materials, as well as any areas of uncertainty.

Still another object of the present invention is to allow the position of the hard and/or soft ferromagnetic elements to be precisely located on the flexible document in a simple, reliable and effective way.

### SUMMARY OF THE INVENTION

It is a specific object of the present invention a system for detecting the magnetization of a flexible document, said detecting system comprising:
a conveyor group, configured to transport the flexible document, received at an inlet opening of the system, along a predefined path having an initial section and a following section;
a first magnetization device, configured to generate a first magnetic field toward the initial section of such a predefined path, the first magnetic field having sufficient intensity to magnetize hard ferromagnetic materials possibly contained in one or more ferromagnetic elements of the flexible document or a portion thereof, when the flexible document transported by the conveyor group or the portion thereof is immersed in the first magnetic field at the initial section of the path;
a second magnetization device, configured to be selectively activated to generate a second magnetic field toward the following section of the predefined path, said second magnetic field having sufficient intensity to magnetize soft ferromagnetic materials possibly contained in one or more of the ferromagnetic elements of the flexible document or a portion thereof, when the flexible document or the portion thereof are immersed in the second magnetic field, at the following section of the predefined path, the intensity of the second magnetic field not exceeding a residual magnetization value Br of the hard ferromagnetic materials possibly present in the one or more ferromagnetic elements of the flexible document or the portion thereof;
a magnetization sensor, arranged at the second magnetization device and configured to detect the magnetization of the one or more ferromagnetic elements of the flexible document or the portion thereof, when the flexible document transported by the conveyor group or the portion thereof is at the following section of the predefined path; and output a corresponding magnetization signal, based on the magnetization thus sensed;
the magnetization sensor and the second magnetization device being arranged downstream of the first magnetization device, along the predefined path of the flexible document, at a distance from the first magnetization device sufficient to allow the soft ferromagnetic materials possibly comprised in the one or more ferromagnetic elements of the flexible document or the portion thereof, to demagnetize naturally before reaching the following section of the predefined path, after having been magnetized by the first magnetization device through application of the first magnetic field, at the initial section of the predefined path,
so that, when the flexible document or said part thereof reach the following section:
   if the second magnetization device is not active and is not generating the second magnetic field, the magnetization signal sensed by the magnetization sensor represents the magnetization of the possible hard ferromagnetic materials of the one or more ferromagnetic elements of the flexible document or the portion thereof; and
   if the second magnetization device is active and is generating the second magnetic field, the magnetization signal sensed by the magnetization sensor represents the magnetization of both the hard ferromagnetic materials and the soft ferromagnetic materials possibly included in the one or more ferromagnetic elements of the flexible document or the portion thereof;
a data control and processing unit, operationally connected to the second magnetization device, the magnetization sensor and the conveyor group and configured for synchronizing the movement of the flexible document by sending control signals to the conveyor group, the selective activation-deactivation of the second magnetization device, the receipt of the magnetization signal outputted by the magnetization sensor right before and right after the activation-deactivation and, based on the magnetization signal received right before and right after the activation-deactivation, calculating the magnetization due to the hard ferromagnetic materials and the magnetization due to the soft ferromagnetic materials comprised in the at least one ferromagnetic element of the respective flexible document or the portion thereof and outputting a corresponding detection signal.

According to another aspect of the invention, the first magnetization device can comprise one or more permanent magnets or one or more electromagnets, the one or more electromagnets being operatively connected to the data control and processing unit and the data control and processing unit being configured to control the selective activation-deactivation of the one or more electromagnets, for the controlled generation of the first magnetic field.

According to a further aspect of the invention, said second magnetization device can include at least one magnetization coil mounted around said magnetization sensor.

According to an additional aspect of the invention, said magnetization sensor can be arranged along the predefined path of the flexible document so as to intercept the flexible document transported by the conveyor group, along a portion of the length or along the entire length or along a portion of the width or along the entire width of the flexible document.

According to another aspect of the invention, said magnetization sensor can comprise a single or multi-channel magneto-inductive head.

According to a further aspect of the invention, each channel of the multi-channel magneto-inductive head can be connected to the data control and processing unit and the magnetization signal can comprise a bundle of signals, each afferent to a respective channel, optionally wherein the channels of the multi-channel magneto-inductive head can be arranged aligned with each other, transversally or parallelly with respect to the direction of movement of the flexible document along the predefined path.

According to an additional aspect of the invention, the data control and processing unit can control the selective activation-deactivation of the second magnetization device, according to a current amplitude and frequency modulation scheme.

According to another aspect of the invention, the system can comprise one analysis unit operatively connected to the data control and processing unit and configured to receive and process the detection signal and to transmit the results of the processing thus performed, outside to the system.

It is also an object of the invention a method of detecting the magnetization of a flexible document with a system as described above, the method comprising the following operational steps:
A. through a first magnetization device, applying a first magnetic field to a flexible document or a part thereof, the first magnetic field sufficient to magnetize the hard ferromagnetic materials possibly comprised in one or more ferromagnetic elements of the flexible document or the portion thereof;
B. allowing the natural demagnetization of the soft ferromagnetic materials possibly comprised in the one or more ferromagnetic elements comprised in that flexible document or portion thereof;
C. through a magnetization sensor, sensing the magnetization of the one or more ferromagnetic elements comprised in the flexible document or in the portion thereof that has been previously magnetized at step A; and
D. transmitting the corresponding magnetization signal to the data control and processing unit;
E. through a second magnetization device, if not being applied yet, applying a second magnetic field, sufficient to magnetize the soft ferromagnetic materials possibly comprised in the one or more ferromagnetic elements, to the flexible document or the portion thereof that has been previously magnetized at step A;
otherwise
F. stopping the application, if already being carried out, of the second magnetic field, sufficient to magnetize the soft ferromagnetic materials possibly comprised in the one or more ferromagnetic elements, to the flexible document or the portion thereof previously magnetized at step A;
G. through the magnetization sensor, sensing the magnetization of the one or more ferromagnetic elements comprised in the flexible document or in the portion thereof, subjected to the action of the second magnetization device; and
H. transmitting the corresponding magnetization signal to the data control and processing unit;
I. through the data control and processing unit and based on the magnetization signals transmitted at step D and H, calculating the magnetization due to the hard ferromagnetic materials and the magnetization due to the soft ferromagnetic materials comprised in the one or more ferromagnetic elements of the flexible document or in the portion thereof being sensed; and
J. outputting a corresponding detection signal.

According to another aspect of the invention, step A can comprise, through the data control and processing unit, selectively activating-deactivating the one or more electromagnets, through emission of suitable control signals by the data control and processing unit operatively connected therewith.

According to a further aspect of the invention, step B can comprise, transporting, through conveyor group, optionally at constant speed, the flexible document between the first magnetization device and the second magnetization device.

According to an additional aspect of the invention, step E and step F can comprise activating or deactivating, through the data control and processing unit, the second magnetization device, optionally following a predefined current amplitude and frequency modulation scheme, in coordination with the sending of control signals to the conveyor group, to synchronize the movement of the flexible document along the predefined path with the magnetization-demagnetization by the second magnetization device.

According to another aspect of the invention, after step J, in the case wherein at step C the magnetization of a portion only of the flexible document is sensed by the magnetization sensor, the method can include a step K comprising:
moving the flexible document of one length along the predefined path, through the emission of suitable control signals by the data control and processing unit to the conveyor group, so that another portion of the flexible document, also previously magnetized according to what is provided at steps A and B and adjacent to the one that has been just sensed, is at the following section of the predefined path, and
going back to step C, and
repeating steps C-K until the magnetization sensor has sensed the magnetization of the whole flexible document.

### BRIEF DESCRIPTION OF THE DRAWINGS

The present invention will now be described, by way of illustration and without limitation, according to its preferred embodiments, with particular reference to the drawings in the attached Figures, wherein:

FIG. 1 shows a schematic perspective side view of a system for detecting the magnetization of a flexible document, according to a preferred embodiment of the present invention;

FIG. 2a is a perspective representation from above, on an enlarged scale, of a magnetization sensor of the system in FIG. 1;

FIG. 2b illustrates a bottom perspective representation of the magnetization sensor of FIG. 2a;

FIG. 3a shows a schematic top view, on an enlarged scale, of an embodiment of the magnetization sensor of the system of FIG. 1;

FIG. 3b is another schematic side view, with transparent parts, of the magnetization sensor of FIG. 3a;

FIG. 4 illustrates a schematic side view, with transparent parts, of the magnetization sensor of FIG. 2a;

FIG. 5a and FIG. 5b show respective representations of detection signals, generated with the system of the present invention; and

FIG. 6 is a flowchart of the flexible document magnetization detection method, according to the present invention.

In the Figures identical reference numbers will be used for similar elements.

### PREFERRED EMBODIMENTS OF THE INVENTION

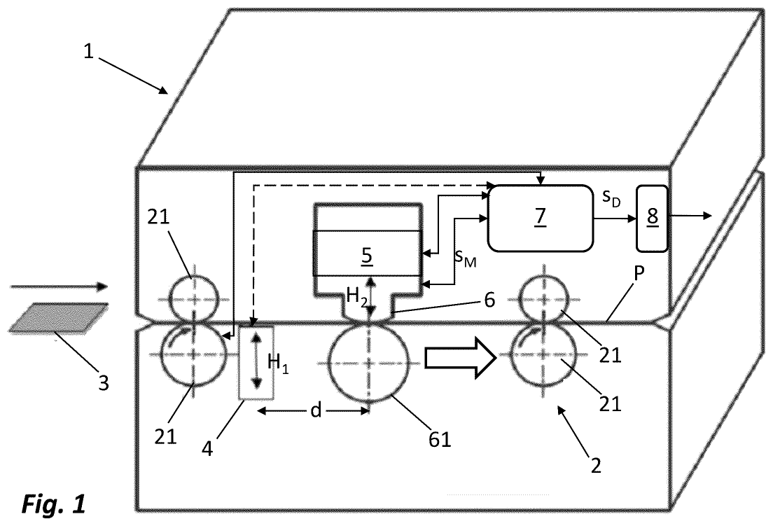

With particular reference to the attached FIG. 1, it will be appreciated that a system for detecting the magnetization of a flexible document according to the present invention is indicated with the reference number 1 and includes a conveyor group 2, for example equipped with one or more pairs of transport rollers 21, configured to transport in a manner known in the field, a flexible document 3 received at an inlet opening of the system, along a predefined path P within the system 1 itself. Note that in FIG. 1 only a pair of rollers 21 are represented at the inlet opening of the system 1 and a pair of rollers 21 near its exit opening, but the conveyor group 2 could also include a greater number of distributed pairs of rollers 21 along the aforementioned path P.

System 1 also includes a first magnetization device 4, for example but not only (as will also be seen below) made with one or more permanent magnets, configured to generate a first magnetic field H₁ towards an initial section of the path P. Such first magnetic field H₁ has sufficient intensity to magnetize the hard ferromagnetic materials possibly contained in one or more ferromagnetic elements of the flexible document 3 or a part thereof, when the flexible document 3 transported by the conveyor group 2 or the part thereof is immersed in the first magnetic field H₁ at the initial section of the predefined path P.

By way of purely illustrative and non-limiting example, the first magnetic field H₁ that can be generated by the first magnetization device 4 can be between 200 Gauss and 20,000 Gauss, but it is understood that the intensity of this magnetic field can change depending on the hard ferromagnetic material included in one or more ferromagnetic elements of the flexible document 3 or the part thereof, subject to It will be easy to understand that the first magnetic field H₁, in addition to having an intensity sufficient to magnetize the hard ferromagnetic materials possibly included in one or more ferromagnetic elements (which at the end of the magnetization, will have a residual magnetization of intensity equal to Br), certainly also magnetizes soft ferromagnetic materials possibly included in such ferromagnetic elements. The latter, however, by their nature, as soon as the magnetizing action of the first H₁ magnetic field has ended, will naturally and quickly tend to demagnetize.

System 1 of the present invention also includes a second magnetization device 5, configured to be selectively activated to generate a second magnetic field H₂ towards a section of the predefined path P, following the initial section. Advantageously, this second magnetic field H₂ has an intensity sufficient to magnetize the soft ferromagnetic materials possibly contained in one or more of the ferromagnetic elements of the flexible document 3 or a part thereof being detected, when the flexible document 3 or the part thereof, transported by the conveyor group 2, are immersed in the second magnetic field H₂ at the following section of the predefined path P. The intensity of the second magnetic field H₂, however, does not exceed the residual magnetization value Br of the hard ferromagnetic materials possibly present in one or more ferromagnetic elements of the flexible document 3 or the part thereof being detected.

According to a preferred variant of the invention, also in order to reduce the power consumption of the system 1 of the invention, the second magnetic field H₂ generated by the second magnetization device 5 can be of a lower intensity than that of the first magnetic field H₁, generated by the first magnetization device 4. For example, by way of example and not by way of limitation, it can have an intensity between 0.1 Gauss and 200 Gauss. However, the person skilled in the art will have no difficulty in understanding how its value can change depending on the soft ferromagnetic material to be magnetized (which, in the specific case of banknotes, varies depending on the currency), included in the one or more ferromagnetic elements of the flexible document 3.

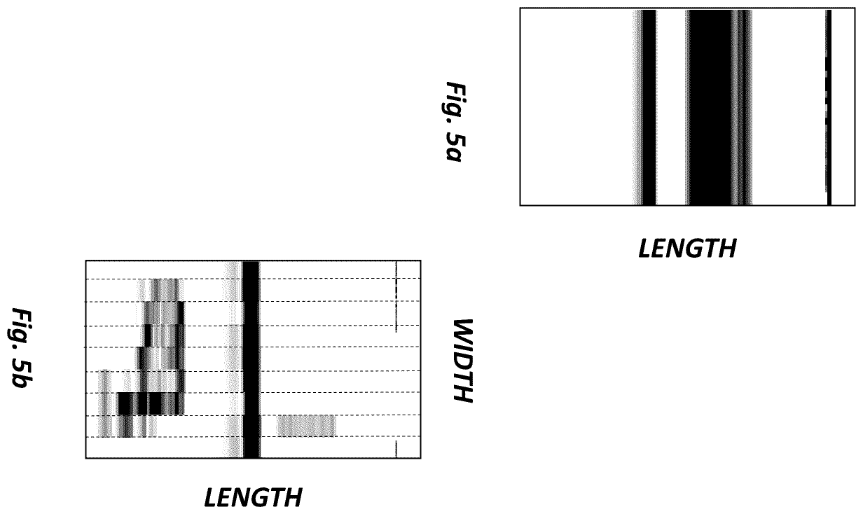

The system 1 of the present invention also includes a magnetization sensor 6, advantageously arranged at the second magnetization device 5 (see FIGS. 1, 2a, 2b and 4). The magnetization sensor 6 is configured to detect the magnetization of one or more ferromagnetic elements of the flexible document 3 or of a part thereof being detected, both in terms of intensity and direction of polarization of the magnetic field emitted by them (hereinafter, for convenience, unless the opposite is specified, the term “magnetization” will refer to both the intensity and the direction of said quantity), when the flexible document 3 transported by the conveyor group 2 or the part thereof is at the following section of the predefined path. The magnetization sensor 6 is also configured to output a corresponding magnetization signal S_{M}, based on the detected magnetization.

According to a preferred embodiment of the present invention, the magnetization sensor 6 is arranged along the predefined path P of the flexible document 3, facing the following section of this predefined path P, so as to intercept the flexible document 3 transported by the conveyor group 2, along a portion of its length or along its entire length or along a portion of its width or along its entire width (the latter case being represented in FIG. 1).

It should also be noted that the correct detection by the magnetization sensor is assisted by the presence of a contrast roller 61, arranged in the system 1 of the invention opposite the magnetization sensor 6, with respect to the predefined path of the flexible document 3. The contrast roller 61 allows, in fact, to keep the flexible document 3 at the correct distance from the magnetization sensor 6, during the detection of its magnetization.

According to a preferred embodiment of the present invention, the second magnetization device 5 comprises at least one magnetization coil mounted around the magnetization sensor 6. In this way, the spaces inside the system 1 of the invention are optimized and it is guaranteed that the magnetization sensor 6 is exactly at the flexible document 3 or the part thereof, when this is hit by the second magnetic field H₂ at the following section of the predefined path P.

In fact, let us remember that soft ferromagnetic materials, once magnetized, tend to naturally demagnetize very quickly, therefore the arrangement of the magnetization sensor 6 at the second magnetization device 5 is crucial to allow the detection of the magnetization of short temporal duration and low intensity, of such soft ferromagnetic materials, when they are magnetized by the second magnetic field H₂.

According to a particularly advantageous aspect of the invention, the magnetization sensor 6 and the second magnetization device 5 are placed in the detection system 1, downstream of the first magnetization device 4, along the predefined path P followed by the flexible document 3 in the system 1, at a distance d from the first magnetization device 4, sufficient to allow the soft ferromagnetic materials possibly included in the one or more ferromagnetic elements of the flexible document 3 or the part thereof being detected, to naturally demagnetize before arriving at the following section of the predefined path P, after having been magnetized by the first magnetization device 4 through the application of the first magnetic field H₁, at the initial section of the predefined path P.

With such a configuration, when the flexible document 3 or a part thereof arrives at the following section:
if the second magnetization device 5 is deactivated and is not generating the second magnetic field H₂, the magnetization signal s_{M} detected by the magnetization sensor 6 represents the magnetization of any hard ferromagnetic materials of the one or more ferromagnetic elements of the flexible document 3 or the part thereof; and
if the second magnetization device 5 is instead active and is therefore generating the second magnetic field H₂, the magnetization signal s_{M} detected by the magnetization sensor 6 represents the magnetization of both the hard ferromagnetic materials and the soft ferromagnetic materials possibly included in the one or more ferromagnetic elements of the flexible document 3 or the part thereof.

Accordingly, a subsequent activation of the second magnetization device 5, in the first case, or a subsequent deactivation of the second magnetization device 5, in the second case, causes a variation in the magnetization signal s_{M}, from which the magnetization of soft ferromagnetic materials, possibly present of one or more ferromagnetic elements of the flexible document 3 or the part thereof, can be obtained.

The system 1 of the present invention also includes a data control and processing unit 7, operationally connected to the conveyor group 2 and configured to control the movement of the flexible document 3 along the predefined path, for example by sending specific control signals to the pairs of transport rollers 21 (see FIG. 1), so that the flexible document 3 is transported from the inlet opening of the system 1, up to the initial section of the predefined path P, to be magnetized by the first magnetization device 4 and, from there, to the following section of the predefined path P, to be magnetized by the second magnetization device 5. The movement of the flexible document 3 can take place according to a pre-established movement scheme, for example at a constant speed, or intermittently with a pre-set step, for example with a length equal to a fraction of the length or width of the flexible document 3 being detected, or fixed.

The data control and processing unit 7 is also operationally connected to the second magnetization device 5 and configured to control its selective activation-deactivation, for example according to an amplitude and frequency modulation scheme of the driving current of the device itself, in synchronization with the movement of the flexible document 3, according to the method of the present invention which will be described below. By way of example and not by way of limitation, the second magnetization device 5, optionally a magnetization coil, can be controlled in current according to an amplitude range between 0 A and 1.5 A and an on and off frequency between 1 ms and 500 ms, when the flexible document 3 is transported along the pre-established path P at a constant speed between 1 m/sec and 2 m/sec. In any case, the person skilled in the art will have no difficulty in understanding how these amplitude and frequency modulation values can vary based on the size and material with which the magnetization coil is made, without thereby falling outside the scope of protection of the present invention.

The data control and processing unit 7 is also operationally connected to the magnetization sensor 6 and configured to receive as input the magnetization signals emitted at the output of the latter, immediately before and immediately after the activation or deactivation of the second magnetization device 5 and to calculate, based on these, the magnetization of the hard ferromagnetic materials and the magnetization of the soft ferromagnetic materials possibly contained in one or more ferromagnetic elements of the flexible document 3.

In this regard, it is specified that the term “immediately before”, in the present description and the following claims, means an instant prior to the activation or deactivation of the second magnetization device 5 and wherein the flexible document 3 or the part thereof subject to detection are located at the following section of the predefined path P, so that the magnetization sensor 6 is able to detect the magnetization thereof. Similarly, it is also specified that the term “immediately after”, in this description and in the following claims, means:
in the first case, any instant following the activation of the second magnetization device 5 (and before its subsequent deactivation), wherein the soft ferromagnetic materials of the one or more ferromagnetic elements of the flexible document 3 or of the part thereof subject to detection are magnetized, and the flexible document 3 or the part thereon subject to detection are still at the following section of the predefined path P, so that the magnetization sensor 6 is able to detect the magnetization thereof;
in the second case, any instant following the deactivation of the second magnetization device 5 (and before its subsequent activation), after the soft ferromagnetic materials of the one or more ferromagnetic elements of the flexible document 3 or of the part thereof subject to detection have become naturally demagnetized, and the flexible document 3 or the part subject to detection are still at the following section of the predefined path P, so that the magnetization sensor 6 is able to detect the magnetization thereof. By way of a purely illustrative and non-limiting example, a time interval sufficient to allow the magnetization-demagnetization of the soft ferromagnetic materials of the one or more ferromagnetic elements of the flexible document 3 or of the part thereof being detected can be between 10 μs and 100 μs, but the skilled person in the art will have no difficulty in understanding how this time interval can vary depending on the type of soft ferromagnetic material.

Going back to the magnetization sensor 6, it is specified that, according to a preferred embodiment of the invention, the magnetization sensor 6 comprises a single or multi-channel magneto-inductive head, depending but not only on the size of the part of the flexible document 3 of which the magnetization must detected. If, for example, the flexible document 3 arrived at the following section of the predefined path P, for the detection of the magnetization by the magnetization sensor 6, presenting its short side (width) at the front as represented in FIG. 1, the number of channels of the magneto-inductive head could be lower than if the flexible document 3 reached this section, presenting its long side (length) at the front.

In this case, according to a preferred aspect of the invention, each channel of the multi-channel magneto-inductive head would be connected to the data control and processing unit 7 and the magnetization signal S_{M} received therefrom would comprise a beam of signals, each belonging to a respective channel.

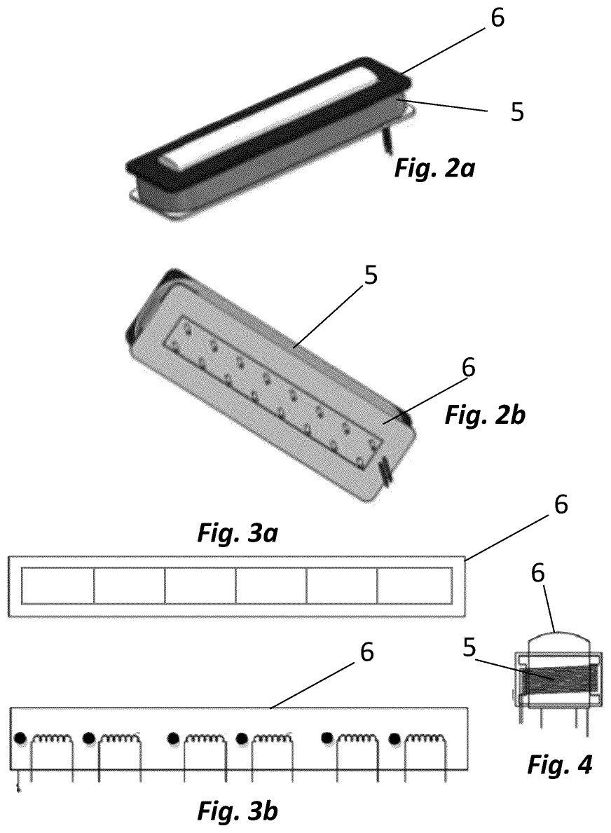

According to some variants of the invention, the channels of the multi-channel magneto-inductive head, as for example represented in FIGS. 2b, 3a and 3b, are arranged aligned with each other and orthogonal with respect to the direction of movement of the flexible document 3 along the predefined path P (see the white arrow in FIG. 1). In any case, the channels of the multi-channel head can also be arranged parallel to the direction of movement of the flexible document 3 along the predefined path P to cover a greater portion thereof.

Returning to the data control and processing unit 7, this is also configured to calculate, for the flexible document 3 or for each part thereof subject to detection, according to the method that will be explained below, a corresponding detection signal s_{D}, whose pattern or value (depending on whether the signal is detected continuously or is sampled) depends on the presence of hard or soft ferromagnetic materials or on the absence of these in the flexible document 3 or in the detected part thereof.

According to a preferred form of the present invention, the calculation is performed by the data control and processing unit 7 by comparing the magnetization s_{M} signals emitted by the magnetization sensor 6, immediately before and immediately after activation or deactivation of the second magnetizing device 5, depending on the case. In fact, the following cases can occur:
(1) the flexible document 3 or the part thereof detected by the magnetization sensor 6 does not include either soft or hard ferromagnetic materials. In this case, the magnetization detected by the magnetization sensor 6 is zero, both immediately before and immediately after the activation or deactivation of the second magnetization device 5 and the corresponding detection signal so is also zero.
(2) the flexible document 3 or the part of flexible document 3 detected by the magnetization sensor 6 comprises only soft ferromagnetic materials and the second magnetization device 5 is deactivated. In this case, the magnetization detected by the magnetization sensor 6 immediately before the activation of the second magnetization device 5 is zero, while the magnetization detected by the magnetization sensor 6 immediately after the activation of the second magnetization device 5 is due only to soft ferromagnetic materials and the s_{D} detection signal corresponds to the s_{M} magnetization signal detected immediately after the activation of the second magnetization device 5.
(3) the flexible document 3 or the part of flexible document 3 detected by the magnetization sensor 6 comprises only soft ferromagnetic materials and the second magnetization device 5 is activated. In this case, the magnetization detected by the magnetization sensor 6 immediately before the deactivation of the second magnetization device 5 is due only to soft ferromagnetic materials while the magnetization detected by the magnetization sensor 6 immediately after the deactivation of the second magnetization device 5 is zero. In this case, the detection signal s_{D} corresponds to the magnetization signal s_{M} detected immediately before the deactivation of the second magnetization device 5.
(4) the flexible document 3 or the part of flexible document 3 detected by the magnetization sensor 6 comprises only hard ferromagnetic materials and the second magnetization device 5 is deactivated. In this case, the magnetization detected by the magnetization sensor 6 immediately before the activation of the second magnetization device 5 is the residual magnetization of intensity Br, due only to the hard ferromagnetic materials, and the intensity of the magnetization detected by the magnetization sensor 6 immediately after the activation of the second magnetization device 5 it is always equal to Br and always due only to hard ferromagnetic materials. In this case, the detection signal s_{D} corresponds to the magnetization signal s_{M} detected immediately before or immediately after the activation of the second magnetization device 5.
(5) the flexible document 3 or the part of flexible document 3 detected by the magnetization sensor 6 comprises only hard ferromagnetic materials and the second magnetization device 5 is activated. In this case, the magnetization detected by the magnetization sensor 6 immediately before the deactivation of the second magnetization device 5 is the residual magnetization of intensity Br and is due only to the hard ferromagnetic materials and the intensity of the magnetization detected by the magnetization sensor 6 immediately after deactivation of the second magnetization device 5 it is always equal to Br and always due only to hard ferromagnetic materials. Also in this case, the detection signal s_{D} corresponds to the magnetization signal s_{M} detected immediately before or immediately after the deactivation of the second magnetization device 5.
(6) the flexible document 3 or the part of flexible document 3 detected by the magnetization sensor 6 comprises both hard and soft ferromagnetic materials and the second magnetization device 5 is deactivated. In this case, the magnetization detected by the magnetization sensor 6 immediately before the activation of the second magnetization device 5 is the residual magnetization of intensity Br and is due only to the hard ferromagnetic materials and the magnetization detected by the magnetization sensor 6 immediately after the activation of the second magnetization device 5 is different from Br due to the magnetization of both hard ferromagnetic materials and the magnetization of soft ferromagnetic materials. In this case, the component of the s_{D} detection signal due to the magnetization of the hard ferromagnetic materials corresponds to the s_{M} magnetization signal detected before the activation of the second magnetization device 5, while the component of the s_{D} detection signal due to the magnetization of the soft ferromagnetic materials corresponds to the difference between the magnetization S_{M} signal detected immediately after the activation of the second magnetization device 5 and that detected immediately before the activation.
(7) the flexible document 3 or the part of flexible document 3 detected by the magnetization sensor 6 comprises both hard and soft ferromagnetic materials and the second magnetization device 5 is activated. In this case, the magnetization detected by the magnetization sensor 6 immediately before the deactivation of the second magnetization device 5 is a magnetization of different intensity from Br and is due both to the magnetization of the hard ferromagnetic materials and to that of the soft ferromagnetic materials, and the intensity of the magnetization detected by the magnetization sensor 6 immediately after the deactivation of the second magnetization device 5 is equal to the residual magnetization of intensity Br and is due to the magnetization of hard ferromagnetic materials only. In this case, the component of the s_{D} detection signal due to the magnetization of the hard ferromagnetic materials corresponds to the s_{M} magnetization signal detected after the deactivation of the second magnetization device 5, while the component of the s_{D} detection signal due to the magnetization of the soft ferromagnetic materials corresponds to the difference between the magnetization signal S_{M} detected before the deactivation of the second magnetization device 5 and the one detected after such deactivation.

In FIGS. 5a and 5b, by way of example, some examples of detection signals s_{D} are provided, which can be calculated by the data control and processing unit 7.

In FIG. 5a, in particular, the corresponding detection signal s_{D} for a banknote being detected by the system 1 of the invention is graphically represented, wherein the magnetization sensor 6 comprises a single channel magneto-inductive head. In this case, as can be seen from the figure, the black transversal lines mark where, compared to the length of the banknote, the magnetization due to ferromagnetic elements including hard ferromagnetic materials has been detected and, the gray lines mark where, on the length of the banknote, the magnetization due to ferromagnetic elements including soft ferromagnetic materials was detected. The white portions concern parts of the banknote without ferromagnetic elements including soft and hard ferromagnetic materials.

In FIG. 5b, however, a detection signal s_{D} is represented for another banknote detected by system 1 of the invention, wherein the magnetization sensor 6 includes a nine-channel magneto-inductive head. In this case, as can be seen in the figure, the black transversal lines do not necessarily extend across the entire width of the banknote and mark where, compared to its length and width, the magnetization due to ferromagnetic elements including hard ferromagnetic materials has been detected. The same applies to the gray lines, which mark where, with respect to both the length and width of the banknote, magnetization due to ferromagnetic elements including soft ferromagnetic materials has been detected. The white portions, also in this case, concern parts of the banknote without ferromagnetic elements including both soft and hard ferromagnetic materials.

This aspect of the present invention is extremely advantageous, because it allows not only to detect the magnetization (in terms of both intensity and direction) of a flexible document 3 due to the presence of soft ferromagnetic materials, but also because it allows determining with high precision the position on the flexible document 3 of all the ferromagnetic elements present therein and to distinguish their nature (whether hard or soft).

It should be noted that the detection signal s_{D}, calculated by the data control and processing unit 7, is not transmitted externally to the system 1 of the invention, for safety reasons, but can instead be sent to a further data analysis unit of the system 1 of the invention, indicated in FIG. 1 with reference 8, for its elaboration. The data analysis unit 8 is in turn configured to process the received detection signal s_{D}, together with other input signals received and to transmit the results of the analysis thus performed externally with respect to system 1. In the specific case of banknotes, the analysis unit 8, on the basis of the detection signal S_{D} and other standard parameters received at the input, will for example be able to determine and provide as output of the system 1 of the invention the type of banknote detected by the system 1, its degree of wear, and possibly its serial number, as well as other parameters useful for its identification.

Returning to the first magnetization device 4 of the system 1, according to a variant of the invention, this can also include one or more electromagnets, each operationally connected to the data control and processing unit 7 and, in this case, the data control and processing unit 7 is configured to selectively control its activation-deactivation for the controlled generation of the first magnetic field H₁. In this case, each electromagnet will contribute to generating a portion of the first magnetic field H₁ which can hit the flexible document 3, when this is at the initial section of the predefined path.

System 1 for detecting the magnetization of a flexible document 3 operates according to a method which also forms the object of the present invention and is described below.

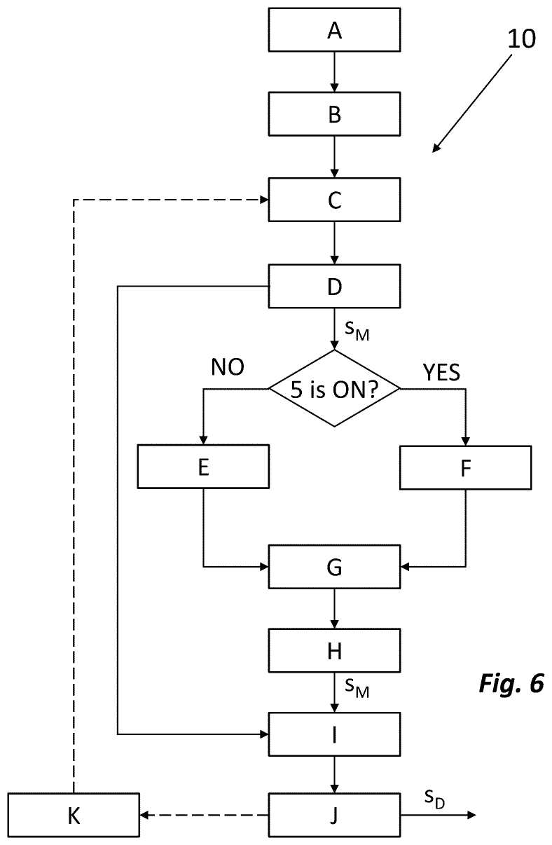

This method, which in FIG. 6 is indicated with reference number 10, includes the following operating steps:
A. by means of a first magnetization device 4, applying to the flexible document 3 or to a part thereof a first magnetic field H₁ sufficient to magnetize the hard ferromagnetic materials possibly contained in one or more ferromagnetic elements of the flexible document 3 or such part thereof;
B. allowing the natural demagnetization of soft ferromagnetic materials possibly contained in one or more ferromagnetic elements included in this flexible document 3 or the part thereof;
C. using a magnetization sensor 6, detecting the magnetization of one or more ferromagnetic elements included in this flexible document 3 or in the part thereof previously magnetized at step A; and
D. transmitting the corresponding magnetization signal S_{M} to the data control and processing unit 7;
E. by means of a second magnetization device 5, applying to the flexible document 3 or to the part thereof previously magnetized at step A, if not already in application, a second magnetic field H₂ sufficient to magnetize the soft ferromagnetic materials possibly contained in one or more ferromagnetic elements;
otherwise
F. stopping the application, if already being carried out, of the second magnetic field H₂ sufficient to magnetize the soft ferromagnetic materials possibly contained in the one or more ferromagnetic elements to the flexible document 3 or the part thereof previously magnetized at step A;
G. using the magnetization sensor 6, detecting the magnetization of the one or more ferromagnetic elements included in this flexible document 3 or the part thereof, thus subjected to the action of the second magnetization device 5; and
H. transmitting the corresponding magnetization signal S_{M} to the data control and processing unit 7;
I. by means of the data control and processing unit 7 and on the basis of the magnetization signals transmitted at step D and step H, calculating, for example as described above or in any other suitable way, the magnetization due to hard ferromagnetic materials and the magnetization due to the soft ferromagnetic materials contained in one or more ferromagnetic elements of the flexible document 3 or in the part thereof subject to detection; and
J. outputting a corresponding detection signal S_{D}.

According to a preferred embodiment of the invention, when the first magnetization device 4 of the system 1 is an electromagnet, step A of method 10 comprises selectively activating-deactivating the one or more electromagnets, by sending appropriate control signals through the data control and processing unit 7 operationally connected thereto.

It should be noted that step B of the invention method 10 can be implemented in different ways. For example, as described above, step B involves transporting, optionally at constant speed, by means of the conveyor group 2 the flexible document 3 between the first magnetization device 4 and the second magnetization device 5, given that these are located at a distance such as to allow the natural demagnetization of the soft ferromagnetic materials possibly present in the one or more ferromagnetic elements of the flexible document 3 or of the part thereof, magnetized by the first magnetization device 4. The transport occurs by sending specific control signals from the data control and processing unit 7 to the pairs of transport rollers 21 of the conveyor group 2. Additionally or alternatively, step B of the invention method 10 comprises modulating the movement speed of the flexible document 3, between the first magnetization device 4 and the second magnetization device 5, for example by causing it to slow down or stop, to allow precisely that sufficient time passes for the soft ferromagnetic materials, possibly present in one or more ferromagnetic elements of the flexible document 3 or its part, to demagnetize.

Step E and step F of the invention detection method, according to a preferred embodiment, comprise, by means of the data control and processing unit 7, activating or deactivating a magnetization coil of the second magnetization device 5, optionally following a predefined current amplitude and frequency modulation scheme, for example like the one described above and in coordination with the sending of the aforementioned control signals sent to the pairs of transport rollers 21 of the conveyor group 2, to synchronize the movement of the flexible document 3 along the predefined path P with magnetization-demagnetization by the second magnetization device 5.

In the event that at step C the magnetization sensor 6 detects the magnetization of only a part of the flexible document 3, the method 10 of the invention includes, after step J, an operational step (step K) wherein the flexible document 3 is advanced along the predefined path P by a length, optionally corresponding to a fraction of the length or width of the flexible document 3, by sending appropriate control signals to the conveyor group 2 by the data control and processing unit 7, so that another part of the flexible document 3, also previously magnetized as foreseen at step A and B and adjacent to the one just detected, is found at the following section of the predefined path, and the method 10 provides then the return to step C, and the repetition of steps C-K until the magnetization sensor 6 has detected the magnetization of the entire flexible document 3.

It is completely clear that system 1 and method 10 of the invention achieve the objectives described in the introduction.

The double magnetization applied to the flexible document 3 or to a part thereof and the coupling between the second magnetization device 5 and magnetization sensor 6 allow determining the magnetization (both in terms of intensity and direction) due both to the presence of hard ferromagnetic materials and soft ferromagnetic materials, possibly included in the ferromagnetic elements of the flexible document 3 or the part thereof subject to detection. Not only that, the use of a multi-channel magnetization sensor 6 allows to precisely identify the position of these ferromagnetic elements (hard and soft) on the flexible document 3 or on the part thereof and this additional information on the ferromagnetic elements of the flexible document 3 and on their position, obtained thanks to system 1 and method 10 of the invention, open the way to new, increasingly refined and reliable recognition methods.

The preferred embodiments of this invention and a number of variations have been described above, but it is understood that the person skilled in the art can implement other variations and modifications without thereby departing from its scope of protection, defined in the attached claims.

1. A system for detecting the magnetization of a flexible document, said detecting system comprising:
a conveyor group, configured to transport the flexible document, received at an inlet opening of the system, along a predefined path having an initial section and a following section;
a first magnetization device, configured to generate a first magnetic field toward the initial section of such a predefined path, the first magnetic field having sufficient intensity to magnetize hard ferromagnetic materials possibly contained in one or more ferromagnetic elements of the flexible document or a portion thereof, when the flexible document transported by the conveyor group or the portion thereof is immersed in the first magnetic field at the initial section of the path;
a second magnetization device, configured to be selectively activated to generate a second magnetic field toward the following section of the predefined path, said second magnetic field having sufficient intensity to magnetize soft ferromagnetic materials possibly contained in one or more of the ferromagnetic elements of the flexible document or a portion thereof, when the flexible document or the portion thereof are immersed in the second magnetic field, at the following section of the predefined path, the intensity of the second magnetic field not exceeding a residual magnetization value of the hard ferromagnetic materials possibly present in the one or more ferromagnetic elements of the flexible document or the portion thereof;
magnetization sensor, arranged at the second magnetization device and configured to detect the magnetization of the one or more ferromagnetic elements of the flexible document or the portion thereof, when the flexible document transported by the conveyor group or the portion thereof is at the following section of the predefined path; and output a corresponding magnetization signal, based on the magnetization thus sensed;
the magnetization sensor and the second magnetization device being arranged downstream of the first magnetization device, along the predefined path of the flexible document, at a distance from the first magnetization device sufficient to allow the soft ferromagnetic materials possibly comprised in the one or more ferromagnetic elements of the flexible document or the portion thereof, to demagnetize naturally before reaching the following section of the predefined path, after having been magnetized by the first magnetization device through application of the first magnetic field, at the initial section of the predefined path,
so that, when the flexible document or said part thereof reach the following section:
if the second magnetization device is not active and is not generating the second magnetic field, the magnetization signal sensed by the magnetization sensor represents the magnetization of the possible hard ferromagnetic materials of the one or more ferromagnetic elements of the flexible document or the portion thereof; and
if the second magnetization device is active and is generating the second magnetic field, the magnetization signal sensed by the magnetization sensor represents the magnetization of both the hard ferromagnetic materials and the soft ferromagnetic materials possibly included in the one or more ferromagnetic elements of the flexible document or the portion thereof;
a data control and processing unit, operationally connected to the second magnetization device, the magnetization sensor and the conveyor group and configured for synchronizing the movement of the flexible document by sending control signals to the conveyor group,
the selective activation-deactivation of the second magnetization device,
the receipt of the magnetization signal outputted by the magnetization sensor right before and right after the activation-deactivation and,
based on the magnetization signal received right before and right after the activation-deactivation, calculating the magnetization due to the hard ferromagnetic materials and the magnetization due to the soft ferromagnetic materials comprised in the at least one ferromagnetic element of the respective flexible document or the portion thereof and outputting a corresponding detection signal.

2. The system according to claim 1, wherein the first magnetization device comprises one or more permanent magnets or one or more electromagnets, the one or more electromagnets being operatively connected to the data control and processing unit and the data control and processing unit being configured to control the selective activation-deactivation of the one or more electromagnets, for the controlled generation of the first magnetic field.

3. The system according to claim 1, wherein the second magnetization device includes at least one magnetization coil mounted around said magnetization sensor.

4. The system according to claim 1, wherein the magnetization sensor is arranged along the predefined path of the flexible document so as to intercept the flexible document transported by the conveyor group, along a portion of the length or along the entire length or along a portion of the width or along the entire width of the flexible document.

5. The system according to claim 1, wherein the magnetization sensor comprises a single or multi-channel magneto-inductive head.

6. The system according to claim 5, wherein each channel of the multi-channel magneto-inductive head is connected to the data control and processing unit and the magnetization signal comprises a bundle of signals, each afferent to a respective channel, optionally wherein the channels of the multi-channel magneto-inductive head are aligned with each other, transversally or parallelly with respect to the direction of movement of the flexible document along the predefined path.

7. The system according to claim 1, wherein the data control and processing unit controls the selective activation-deactivation of the second magnetization device, according to a current amplitude and frequency modulation scheme.

8. The system according to claim 1, comprising one analysis unit operatively connected to the data control and processing unit and configured to receive and process the detection signal and to transmit the results of the processing thus performed, outside to the system.

9. A method of detecting the magnetization of a flexible document with a system comprising:
a conveyor group, configured to transport the flexible document, received at an inlet opening of the system, along a predefined path having an initial section and a following section;
a first magnetization device, configured to generate a first magnetic field toward the initial section of such a predefined path, the first magnetic field having sufficient intensity to magnetize hard ferromagnetic materials possibly contained in one or more ferromagnetic elements of the flexible document or a portion thereof, when the flexible document transported by the conveyor group or the portion thereof is immersed in the first magnetic field at the initial section of the path;
a second magnetization device, configured to be selectively activated to generate a second magnetic field toward the following section of the predefined path, said second magnetic field having sufficient intensity to magnetize soft ferromagnetic materials possibly contained in one or more of the ferromagnetic elements of the flexible document or a portion thereof, when the flexible document or the portion thereof are immersed in the second magnetic field, at the following section of the predefined path, the intensity of the second magnetic field not exceeding a residual magnetization value of the hard ferromagnetic materials possibly present in the one or more ferromagnetic elements of the flexible document or the portion thereof;
a magnetization sensor, arranged at the second magnetization device and configured to detect the magnetization of the one or more ferromagnetic elements of the flexible document or the portion thereof, when the flexible document transported by the conveyor group or the portion thereof is at the following section of the predefined path; and output a corresponding magnetization signal, based on the magnetization thus sensed;
the magnetization sensor and the second magnetization device being arranged downstream of the first magnetization device, along the predefined path of the flexible document, at a distance from the first magnetization device sufficient to allow the soft ferromagnetic materials possibly comprised in the one or more ferromagnetic elements of the flexible document or the portion thereof, to demagnetize naturally before reaching the following section of the predefined path, after having been magnetized by the first magnetization device through application of the first magnetic field, at the initial section of the predefined path,
so that, when the flexible document or said part thereof reach the following section:
if the second magnetization device is not active and is not generating the second magnetic field, the magnetization signal sensed by the magnetization sensor represents the magnetization of the possible hard ferromagnetic materials of the one or more ferromagnetic elements of the flexible document or the portion thereof; and
if the second magnetization device is active and is generating the second magnetic field, the magnetization signal sensed by the magnetization sensor represents the magnetization of both the hard ferromagnetic materials and the soft ferromagnetic materials possibly included in the one or more ferromagnetic elements of the flexible document or the portion thereof;
a data control and processing unit, operationally connected to the second magnetization device, the magnetization sensor and the conveyor group and configured for synchronizing the movement of the flexible document by sending control signals to the conveyor group, the selective activation-deactivation of the second magnetization device, the receipt of the magnetization signal outputted by the magnetization sensor right before and right after the activation-deactivation and,
based on the magnetization signal received right before and right after the activation-deactivation, calculating the magnetization due to the hard ferromagnetic materials and the magnetization due to the soft ferromagnetic materials comprised in the at least one ferromagnetic element of the respective flexible document or the portion thereof and outputting a corresponding detection signal;
the method comprising the following operational steps:
A. through a first magnetization device, applying a first magnetic field to a flexible document or a part thereof, the first magnetic field sufficient to magnetize the hard ferromagnetic materials possibly comprised in one or more ferromagnetic elements of the flexible document or the portion thereof;
B. allowing the natural demagnetization of the soft ferromagnetic materials possibly comprised in the one or more ferromagnetic elements comprised in that flexible document or portion thereof;
C. through a magnetization sensor, sensing the magnetization of the one or more ferromagnetic elements comprised in the flexible document or in the portion thereof that has been previously magnetized at step A; and
D. transmitting the corresponding magnetization signal to the data control and processing unit;
E. through a second magnetization device, if not being applied yet, applying a second magnetic field, sufficient to magnetize the soft ferromagnetic materials possibly comprised in the one or more ferromagnetic elements, to the flexible document or the portion thereof that has been previously magnetized at step A;
otherwise
F. stopping the application, if already being carried out, of the second magnetic field, sufficient to magnetize the soft ferromagnetic materials possibly comprised in the one or more ferromagnetic elements, to the flexible document or the portion thereof previously magnetized at step A;
G. through the magnetization sensor, sensing the magnetization of the one or more ferromagnetic elements comprised in the flexible document or in the portion thereof, subjected to the action of the second magnetization device; and
H. transmitting the corresponding magnetization signal to the data control and processing unit;
I. through the data control and processing unit and based on the magnetization signals transmitted at step D and H, calculating the magnetization due to the hard ferromagnetic materials and the magnetization due to the soft ferromagnetic materials comprised in the one or more ferromagnetic elements of the flexible document or in the portion thereof being sensed; and
J. outputting a corresponding detection signal.

10. The method according to claim 9, wherein the first magnetization device of the system comprises one or more permanent magnets or one or more electromagnets, the one or more electromagnets being operatively connected to the data control and processing unit and the data control and processing unit being configured to control the selective activation-deactivation of the one or more electromagnets, for the controlled generation of the first magnetic field, and wherein step A comprises, through the data control and processing unit, selectively activating-deactivating the one or more electromagnets, through emission of suitable control signals by the data control and processing unit operatively connected therewith.

11. The method according to claim 9, wherein step B comprises, transporting, through conveyor group, optionally at constant speed, the flexible document between the first magnetization device and the second magnetization device.

12. The method according to any claim 9, wherein step E and step F comprise activate or deactivate, through the data control and processing unit, the second magnetization device, optionally following a predefined current amplitude and frequency modulation scheme, in coordination with the sending of control signals to the conveyor group, to synchronize the movement of the flexible document along the predefined path with the magnetization-demagnetization by the second magnetization device.

13. The method according to any claim 9, comprising, after step J, in the case wherein at step C the magnetization of a portion only of the flexible document is sensed by the magnetization sensor, one step K comprising:
moving the flexible document of one length along the predefined path, through the emission of suitable control signals by the data control and processing unit to the conveyor group, so that another portion of the flexible document, also previously magnetized according to what is provided at steps A and B and adjacent to the one that has been just sensed, is at the following section of the predefined path, and
going back to step C, and
repeating steps C-K until the magnetization sensor has sensed the magnetization of the whole flexible document.
